(19) United States
(12) Patent Application Publication
(10) Pub. No.: US 2020/0174204 A1
(43) Pub. Date: Jun. 4, 2020

(54) BI-DIRECTIONAL OPTICAL SUB-ASSEMBLY AND OPTICAL MODULE

(71) Applicant: HISENSE BROADBAND MULTIMEDIA TECHNOLOGIES CO., LTD., QINGDAO (CN)

(72) Inventor: JIANPING GE, QINGDAO (CN)

(21) Appl. No.: 16/730,724

(22) Filed: Dec. 30, 2019

Related U.S. Application Data
(63) Continuation of application No. PCT/CN2019/114108, filed on Oct. 29, 2019.

(30) Foreign Application Priority Data
Oct. 29, 2018 (CN) 201811269487.8

(51) Int. Cl. G02B 6/42; H04B 10/25

(52) U.S. Cl. CPC G02B 6/4208; H04B 10/2503

(57) ABSTRACT

Embodiments of the present application provide a bi-directional optical sub-assembly and an optical module, including: a laser chip, a Faraday rotator, a polarization detection filter, a detector chip, and an optical fiber ferrule; the laser chip, the Faraday rotator, the polarization detection filter and the optical fiber ferrule are sequentially disposed on a first optical axis; after polarized light emitted by the laser chip is rotated by the Faraday rotator, a direction of state of polarization of the polarized light is as same as a direction of polarization detection of the polarization detection filter; the rotated polarized light is then injected into the optical fiber ferrule for transmission, and light from the optical fiber ferrule is injected into the detector chip after being reflected by the polarization detection filter.

### CROSS-REFERENCE TO RELATED APPLICATIONS

This application is a continuation application of the International application PCT/CN2019/114108, filed on Oct. 29, 2019, entitled “Bi-directional optical sub-assembly and optical module”, which claims priority to Chinese Patent Application No. 201811269487.8, filed on Oct. 29, 2018, entitled “Bi-directional optical sub-assembly and optical module”. Both of the above applications are hereby incorporated by reference in their entireties.

### TECHNICAL FIELD

Embodiments of the present application relate to the field of optical communication and, in particular, to a bi-directional optical sub-assembly and an optical module.

### BACKGROUND

With the development of optical communication, the bi-directional technology, which enables an increasing amount of data transmission and a saving in fiber resources, has achieved rapid development. A bi-directional optical sub-assembly (BOSA) is an important component for bi-directional communication.

### SUMMARY

Embodiments of the present application provide a bi-directional optical sub-assembly and an optical module.

In a first aspect, an embodiment of the present application provides a bi-directional optical sub-assembly, including: a laser chip, a Faraday rotator, a polarization detection filter, a detector chip, and an optical fiber ferrule;

the laser chip, the Faraday rotator, the polarization detection filter and the optical fiber ferrule are sequentially disposed on a first optical axis, where the detector chip is disposed on a second optical axis, the polarization detection filter is disposed on an intersection point of the first optical axis and the second optical axis in an inclined manner;

After polarized light emitted by the laser chip is rotated by the Faraday rotator, a direction of state of polarization of the polarized light is as same as a direction of polarization detection of the polarization detection filter. The rotated polarized light is then injected into the optical fiber ferrule for transmission. Light from the optical fiber ferrule is injected into the detector chip after being reflected by the polarization detection filter.

In a second aspect, an embodiment of the present application provides an optical module, including the bi-directional optical sub-assembly according to the first aspect.

### BRIEF DESCRIPTION OF DRAWINGS

In order to illustrate technical solutions of the embodiments of the present application, drawings used in the embodiments will be briefly described below. It is apparent that the drawings in the following description are only some embodiments of the present application; other drawings may be obtained by those of ordinary skill in the art without paying any creative efforts.

FIG. 1 is a schematic structural diagram of a bi-directional optical sub-assembly according to an embodiment of the present application;

FIG. 2 is a schematic diagram illustrating a principle of implementing polarization function of a polarization detection filter according to an embodiment of the present application;

FIG. 3 is a schematic structural diagram of a bi-directional optical sub-assembly according to an embodiment of the present application;

FIG. 4 is a schematic diagram of an optical path of a bi-directional optical sub-assembly according to an embodiment of the present application; and

FIG. 5 is a schematic structural diagram of a bi-directional optical sub-assembly according to an embodiment of the present application.

### DESCRIPTION OF REFERENCE SIGNS

X: first optical axis;
Y: second optical axis;
P: P light;
S: S light;
10: isolating and beam splitting system;
11: laser chip;
12: Faraday rotator;
13: polarization detection filter;
14: detector chip;
15: optical fiber ferrule;
16: first converging lens;
17: second converging lens;
18: zero-degree filter;
19: magnetic ring.

### DESCRIPTION OF EMBODIMENTS

Exemplary embodiments will be described in detail herein, examples of which are illustrated in the accompanying drawings. Identical numerals in different drawings refer to the same or similar elements unless otherwise indicated. Implementations described in the following exemplary embodiments do not represent all embodiments that are consistent with the present application. Instead, they are merely examples of devices and methods that are consistent with aspects of the present application as detailed in the appended claims.

The terms “including” and “comprising”, and any variations thereof, are intended to cover a non-exclusive inclusion. For example, a process, a method, a system, a product, or a device that includes a series of steps or units is not limited to the listed steps or units, but alternatively also includes steps or units not listed, or alternatively includes other steps or units inherent to the process, method, product or device.

The terms “first” and “second” in the present application are used for identification purposes only and are not to be construed as indicating or implying a sequential relationship, relative importance, or implicit indication of the number of technical features indicated. “Multiple” means two or more. “And/or” describes an association relationship of associated objects, indicating that there may be three relationships. For example, A and/or B may indicate that there are three cases, namely, only A exists, A and B exist at the same time, and only B exists. The character “/” generally indicates an “or” relationship between associated objects.

The “one embodiment” or “an embodiment” throughout the description of the present application indicates that a particular feature, structure or characteristic relating to the embodiment is included in at least one embodiment of the present application. Thus, “in one embodiment” or “in an embodiment” throughout the description of the present application are not necessarily referring to the same embodiment. It should be noted that features in the embodiments may be combined with each other without conflict.

With the rapid development of optical communication, there is an increasing demand for optical module products in an access network. In the entire optical module, the cost of a bi-directional optical sub-assembly accounts for more than 80%, and the cost of an isolator accounts for more than 20% of the cost of the bi-directional optical sub-assembly. It is the focus of communication companies to lower the cost of the bi-directional optical sub-assembly and improve production efficiency, and the lowering of the cost of the isolator can effectively reduce the cost of the bi-directional optical sub-assembly.

An isolator is a passive device that only allows light to travel in a forward direction of an optical path, preventing reflected light from returning to a laser. In an optical path without the isolator, light emitted by the laser is reflected by a fiber end face and a jumper joint, and part of the light returns to the laser along the original optical path. When the intensity of the reflected light reaches a certain level, the modulation characteristics and spectral characteristics of the laser are affected, thereby affecting the transmission quality of the emitted signal. To ensure a stable operation of a communication system, it is necessary to add an isolator behind the laser chip to ensure the integrity of signal transmission in the optical fiber communication.

An isolator in a bi-directional optical sub-assembly may be a three-piece isolator (polaroid-Faraday rotator-polaroid) or a two-piece isolator (Faraday rotator-polaroid). The two-piece isolator saves one polaroid compared to the three-piece isolator, thereby having an advantage in production costs and material costs.

The isolation principle of the optical assembly using a two-piece isolator is as follows. Polarized light emitted by a laser chip passes through a converging lens without changing its state of polarization; the converged polarized light passes through a Faraday rotator, and the state of polarization of the light rotates 45 degrees counterclockwise; when the polarized light passes through an analyzer, the state of polarization of the light is as same as the direction of polarization detection of the analyzer, and all the light passes through the analyzer; and then the polarized light passes through a 45-degree filter and is coupled into a fiber for transmission, so as to realize a function of transmitting an optical signal; after light emitted by a core of a fiber (core) is reflected by the 45-degree filter, an optical path is deflected by 90 degrees; and then the light is converged by a converging lens to a detector chip, so as to realize a function of receiving an optical signal. Reflected light reflected from an end face of the core and the inside of the fiber has a random state of polarization, after the reflected light passes through a 45-degree filter, the state of polarization of the light is still random, and after the reflected light passes through an analyzer, polarized light with the same state of polarization as the direction of polarization detection of the analyzer passes through, while light with other states of polarizations is absorbed, which greatly reduces the energy of the reflected light; after the reflected light passing through the analyzer passes through a Faraday rotator, the state of polarization of the light continues to rotate 45 degrees counterclockwise (from the direction of light emission). At this time, the state of polarization of the light is rotated by 90 degrees compared to the incident light, the energy of the reflected light is greatly reduced and the state of polarization of the reflected light is perpendicular to the state of polarization of the emitted light and therefore will not affect normal operations of the laser.

In the bi-directional optical sub-assembly using the two-piece isolator, the encapsulation of a laser chip and the bonding of an isolator are subject to directional requirements. After a direction of the laser chip is fixed, a bonding direction of the isolator must be fixed to ensure that a state of polarization of light is as same as the direction of polarization detection of the analyzer after the light is rotated by a Faraday rotator. Therefore, in the production process of the isolator, it is necessary to make a polarization identification point on the outside of the isolator to identify the polarization direction of the analyzer. If the bonding direction deviates, light passing through the analyzer will be reduced. The greater the degree of the deviation, the greater the loss of light, thus resulting in a damage to an emitted optical signal, which in turn affects the transmission quality of the emitted signal.

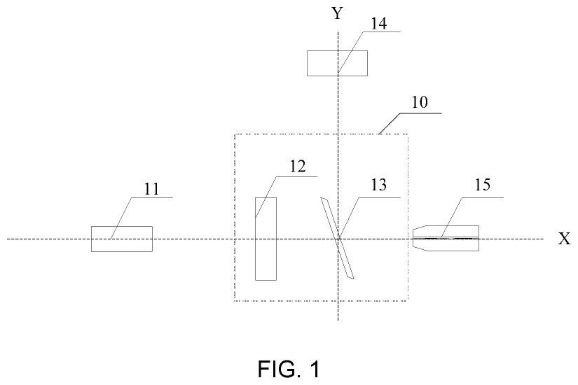

FIG. 1 is a schematic structural diagram of a bi-directional optical sub-assembly according to an embodiment of the present application. As shown in FIG. 1, the bi-directional optical sub-assembly according to the embodiment may include a laser chip 11, a Faraday rotator 12, a polarization detection filter 13, a detector chip 14 and an optical fiber ferrule 15.

The laser chip 11, the Faraday rotator 12, the polarization detection filter 13 and the optical fiber ferrule 15 are sequentially disposed on a first optical axis X, the detector chip 14 is disposed on a second optical axis Y, the polarization detection filter 13 is disposed on an intersection point of the first optical axis X and the second optical axis Y in an inclined manner. It should be understood that when the polarization detection filter 13 is inclined to the left, the detector chip 14 is located above the X-axis, and when the polarization detection filter 13 is inclined to the right, the detector chip 14 is located below the X-axis. Orientations used in the embodiment are all described by taking orientations shown in FIG. 1 as an example. An inclined angle of the polarization detection filter 13 can be set according to actual needs, so that an optical signal reflected by the polarization detection filter can be received by the detector chip. The configuration of the inclined angle is not particularly limited in the embodiment.

In the embodiment, the Faraday rotator 12 and the polarization detection filter 13 together form an isolating and beam splitting system 10 of the bi-directional optical sub-assembly, realizing both functions of beam splitting and isolating. The isolating and beam splitting system 10 is used to transmit an optical signal emitted by the laser chip 11 to the optical fiber ferrule 15 for transmission, reflect a received optical signal received by the optical fiber ferrule 15 to the detector chip 14, and prevent a reflected light from returning to the laser chip 11 at the same time.

After polarized light emitted by the laser chip 11 is rotated by the Faraday rotator 12, the state of polarization of the light is as same as the direction of polarization detection of the polarization detection filter 13. The rotated polarized light is then injected into the optical fiber ferrule 15 for transmission, and light from the optical fiber ferrule 15 is injected into the detector chip 14 after being reflected by the polarization detection filter 13.

The wavelength of the polarized light emitted by the laser chip 11 in the embodiment is different from the wavelength of light that can be received by the detector chip 14.

After the polarized light emitted by the laser chip 11 is rotated by the Faraday rotator 12, the state of polarization thereof is as same as the direction of polarization detection of the polarization detection filter 13, so that the polarized light emitted by the laser chip 11 can be ensured to pass through the polarization detection filter 13 as much as possible, thereby reducing the optical loss, improving the coupling efficiency, and improving the reliability of optical communication.

In some embodiments, the polarization detection filter 13 in the embodiment transmits P light and reflects S light.

In the embodiment, after the polarized light emitted by the laser chip 11 is rotated by the Faraday rotator 12, the state of polarization thereof is rotated counterclockwise by 45 degrees (from the direction of light emission). Polarized light in the same direction as the direction of polarization detection of the polarization detection filter 13 passes through the polarization detection filter 13, which is then converged at a fiber end face of the optical fiber ferrule 15, and is coupled to the fiber in the optical fiber ferrule 15 for transmission. Reflected light reflected from the fiber end face of the optical fiber ferrule 15 and the inside of the fiber has a random state of polarization, in the reflected light, only light having the state of polarization that is as same as the direction of the polarization detection of the polarization detection filter 13 can pass through the polarization detection filter 13, while light having other states of polarization will be reflected, so that the energy of the reflected light passing through the polarization detection filter 13 is greatly reduced. After passing through the Faraday rotator 12, the state of polarization of the reflected light continues to rotate counterclockwise by 45 degrees (from the direction of light emission). At this time, the state of polarization of the reflected light is rotated by 90 degrees compared to the incident light, the energy of the reflected light is greatly reduced and the state of polarization of the reflected light is perpendicular to the state of polarization of the emitted light and therefore will have less effect on normal operations of the laser chip 11.

The bi-directional optical sub-assembly according to the embodiment includes a laser chip, a Faraday rotator, a polarization detection filter, a detector chip, and an optical fiber ferrule; the laser chip, the Faraday rotator, the polarization detection filter and the optical fiber ferrule are sequentially disposed on a first optical axis, the detector chip is disposed on a second optical axis, the polarization detection filter is disposed on an intersection point of the first optical axis and the second optical axis in an inclined manner. Since after polarized light emitted by the laser chip is rotated by the Faraday rotator, a direction of state of polarization of the polarized light is as same as a direction of polarization detection of the polarization detection filter, it is possible to inject the polarized light into the optical fiber ferrule for transmission, so as to realize a transmitting of an optical signal; the light from the optical fiber ferrule is reflected by the polarization detection filter and then injected into the detector chip, so as to realize a receiving of the optical signal, that is, to realize a bi-directional optical communication.

The bi-directional optical sub-assembly according to some embodiments of the present application uses the Faraday rotator and the polarization detection filter to allow light emitted by the laser chip to be injected into the optical fiber ferrule for transmission, but for reflected light with a random state of polarization that is reflected by the fiber end face of the optical fiber ferrule and the inside of the fiber, only light having a state of polarization that is as same as the direction of polarization detection of the polarization detection filter is allowed to pass through the polarization detection filter and injected into the Faraday rotator. The energy of the reflected light is greatly reduced, besides, after the reflected light is rotated by the Faraday rotator, the state of polarization of the reflected light injected into the Faraday rotator is perpendicular to the state of polarization of the emitted light and therefore will not affect normal operations of the laser chip. In this way, both functions of beam splitting and isolating are realized, thereby simplifying the optical path of the bi-directional optical sub-assembly and lowering material costs.

It can be understood that, comparing with the bi-directional optical sub-assembly using a two-piece isolator, the bi-directional optical sub-assembly according to the embodiment can save one analyzer, simplify the optical path of the bi-directional optical sub-assembly and reduce material costs. According to the bi-directional optical sub-assembly, when bonding the Faraday rotator, it is not required to fix the bonding direction, which can effectively avoid optical loss due to a deviation of the bonding direction and simplify the bonding process, thereby greatly increasing the production efficiency.

In some embodiments, the first optical axis and the second optical axis can be disposed to be perpendicular to each other.

In some embodiments, both functions of beam splitting and polarization detection of the polarization detection filter of the bi-directional optical sub-assembly may be implemented as follows: depositing a surface of the polarization detection filter with a film layer having a first refractive index and a film layer having a second refractive index in turn, where the first refractive index is greater than the second refractive index. That is, the film layer having the first refractive index and the film layer having the second refractive index may be deposited on any one surface of the polarization detection filter in turn, or the film layer having the first refractive index and the film layer having the second refractive index may be deposited on both surfaces of the polarization detection filter in turn. The thickness and the number of layers of the film layer having the first refractive index and the film layer having the second refractive index are not limited by the embodiment.

In some embodiments, both functions of beam splitting and polarization detection of the polarization detection filter of the bi-directional optical sub-assembly may be implemented as follows: depositing a surface of the polarization detection filter with a film layer having a first refractive index and a film layer having a second refractive index alternately, where the first refractive index is greater than the second refractive index. That is, the film layer having the first refractive index and the film layer having the second refractive index may be alternately deposited on any one surface of the polarization detection filter, or the film layer having the first refractive index and the film layer having the second refractive index may be alternately deposited on both surfaces of the polarization detection filter. The thickness and the number of layers of the film layer having the first refractive index and the film layer having the second refractive index are not limited by the embodiment.

In some embodiments of the present application, the film layer having the first refractive index and the film layer having the second refractive index are both disposed on a side of the polarization detection filter facing the Faraday rotator.

In some embodiments of the present application, the film layer having the first refractive index and the film layer having the second refractive index are both disposed on a side of the polarization detection filter facing the optical fiber ferrule.

In some embodiments of the present application, the side of the polarization detection filter which faces the optical fiber ferrule and the side of the polarization detection filter which faces the Faraday rotator are both provided with the film layer having the first refractive index and the film layer having the second refractive index.

In the embodiment of the present application, the polarization detection filter may, depending on wavelengths, selectively let the light emitted by the laser and the light transmitted by the optical fiber pass, where the light emitted by the laser and the light transmitted by the optical fiber have different wavelengths and different frequencies.

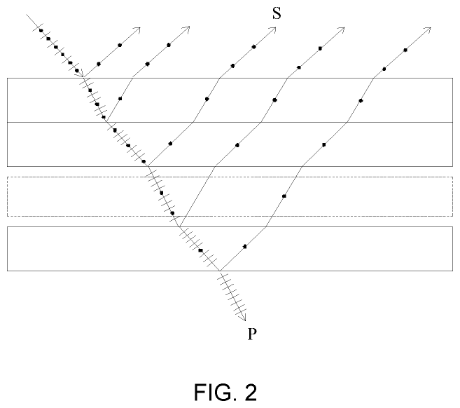

FIG. 2 is a schematic diagram illustrating the principle of implementing polarization function of the polarization detection filter according to an embodiment of the present application. As shown in FIG. 2, each rectangular block in the figure represents a film layer, where refractive indices of adjacent film layers are different. For the convenience of presentation, a plurality of film layers not shown in the figure are indicated by a dotted rectangular block in FIG. 2. When light is reflected and refracted at an interface of a medium, reflection coefficients of the P light and the S light are different, and the reflected light and the transmitted light are usually partially polarized light. When an incident angle of incident light is equal to the Brewster's angle, the reflected light becomes S linearly polarized light, but the intensity is relatively small (S light is reflected about 15% at a time). The intensity of the transmitted light is relatively large, but the degree of polarization is relatively small. In the embodiment, by alternately depositing a first film layer having a high refractive index and a second film layer having a low refractive index on a surface of a slide, light is repeatedly reflected and refracted between the film layers to realize the polarization detection function of reflecting S light and transmitting P light. If the incident light is P light, all the light passes the polarization detection filter, thus realizing the polarization detection function.

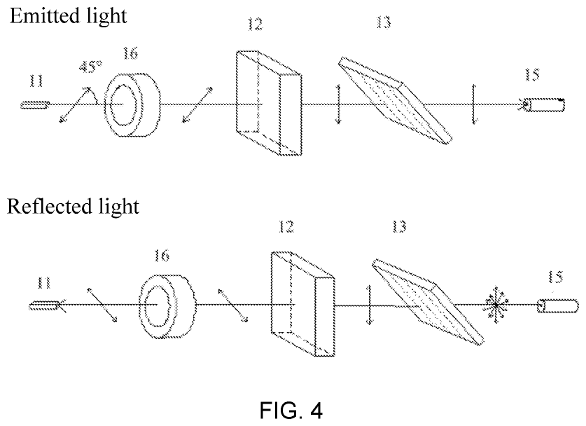

FIG. 4 is a schematic diagram of an optical path of a bi-directional optical sub-assembly according to an embodiment of the present application. The laser is assembled in a specific direction to ensure that the polarization direction of the emitting light is at an angle of 45 degrees with respect to the plane on which the bi-directional optical sub-assembly is disposed. After the light passes through the Faraday, the state of polarization is rotated counterclockwise by 45 degrees (from the direction of light emission), and the light incident on the polarization detection filter is all P light, all of which is transmitted through the slide, thereby realizing the polarization detection function.

The polarization detection function of the polarization detection filter requires the following conditions: the incident light is incident on the surface of the slide at Brewster's angle; the laser is assembled in a specific direction so that the light incident on the polarization detection filter, after experiencing the Faraday rotation, is ensured to be P light. The function of Faraday is to rotate the state of polarization of the light by 45 degrees. As long as the light incident surface is ensured to be perpendicular to the direction of the light when the Faraday is being assembled, the rotation of the light can thereby be realized.

The traditional two-piece isolator consists of a Faraday and an analyzer glued together. The state of polarization of the light after the Faraday rotation must be consistent with the direction of the analyzer to let the light pass. Therefore, when assembling the isolator, it must be ensured that the analyzer is at a 45 degree angle with respect to the state of polarization of the light emitted by the laser. Seen from the direction of light emission, the direction of polarization detection of the analyzer is rotated 45 degrees counterclockwise with respect to the direction of polarization of the light. Compared with the present application, the direction of the conventional isolator needs to be fixed in its assembling, otherwise the light will be absorbed by the analyzer.

After the light emitted by the laser chip is rotated by the Faraday rotator, the state of polarization of the rotated light is as same as the direction of polarization detection of the polarization detection filter. That is, P light can pass through the polarization detection filter and be transmitted to the fiber in the optical fiber ferrule to realize a transmitting of an optical signal. The state of polarization of reflected light reflected by the core end face and by the inside of the fiber is random. It can be understood that a large amount of S light is contained therein, after passing through the polarization detection filter, most of S light is isolated, and the energy of the reflected light is greatly reduced.

In some embodiments, a film layer having a first refractive index and a film layer having a second refractive index in the embodiment may be determined according to the wavelength of light used for transmitting signals in bi-directional optical communication. For example, when the wavelength of light emitted by the laser chip is 1490 nm and the wavelength of light received by the detector chip is 1310 nm, the film layer having the first refractive index in the embodiment may be a film layer of tantalum pentoxide Ta₂O₅, and the film layer having the second refractive index may be a film layer of silicon dioxide SiO₂. It can be understood that the film layer having the first refractive index and the film layer having the second refractive index may also be replaced by other film layers having the same or similar refractive indices.

According to the bi-directional optical sub-assembly of the embodiment, the film layer having the first refractive index and the film layer having the second refractive index are alternately deposited on the surface of the polarization detection filter to enable the polarization detection filter to have both functions of isolating and beam splitting. The bi-directional optical sub-assembly realizes both functions of beam splitting and isolating through the cooperation of the Faraday rotator and the polarization detection filter. Comparing with the bi-directional optical sub-assembly with a two-piece isolator, the bi-directional optical sub-assembly according to the embodiment can save one analyzer, simplify the optical path of the bi-directional optical sub-assembly and reduce material costs. Further, according to the bi-directional optical sub-assembly, when bonding the Faraday rotator, it is not required to fix the bonding direction, which can effectively avoid optical loss due to a deviation of the bonding direction and simplify the bonding process, thereby greatly increasing the production efficiency.

In some embodiments, the film layer having the first refractive index may be a film layer of tantalum pentoxide Ta₂O₅, and the film layer having the second refractive index may be a film layer of silicon dioxide silicon dioxide SiO₂.

In some embodiments, the wavelength of light emitted by the laser chip 11 may be 1490 nm, and the wavelength of light received by the detector chip 14 may be 1310 nm.

In some embodiments, an angle between the polarization detection filter 13 and the first optical axis may be (45±0.5) degrees.

In some embodiments, a first converging lens 16 on the first optical axis X may be disposed between the laser chip 11 and the Faraday rotator 12, where the first converging lens 16 is configured to converge the polarized light emitted by the laser chip 11 to the Faraday rotator 12, such that as much light as possible is eventually converged into the optical fiber ferrule for transmission. The first converging lens 16 converges the polarized light emitted from the laser chip 11, in this way, the coupling efficiency of the emitted optical signal can be improved.

In some embodiments, a second converging lens 17 on the second optical axis Y may be disposed between the detector chip 14 and the polarization detection filter 13, where the second converging lens 17 is configured to converge the light reflected by the polarization detection filter 13 to the detector chip 14. The second converging lens 17 converges the light reflected by the polarization detection filter 13, in this way, the coupling efficiency of the received optical signal can be improved.

In some embodiments, a zero-degree filter 18 on the second optical axis Y may also be disposed between the second converging lens 17 and the polarization detection filter 13. By filtering light reflected by the polarization detection filter 13 via the zero-degree filter 18, interference of an interference optical signal on a received optical signal can be avoided, where the interference optical signal includes an optical signal having a wavelength not equal to the wavelength of the received optical signal.

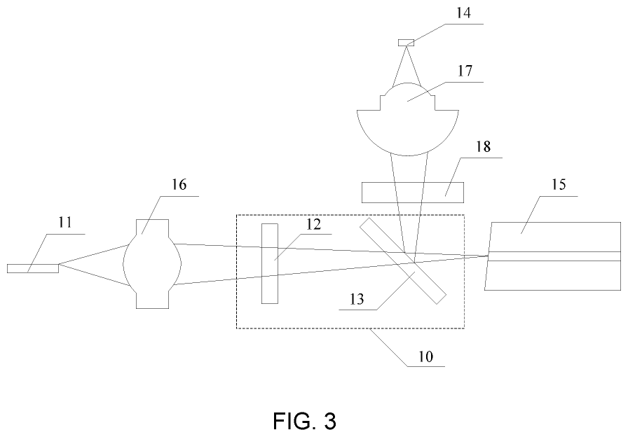

Based on the above embodiments, the present embodiment combines the above embodiments. FIG. 3 is a schematic structural diagram of a bi-directional optical sub-assembly according to an embodiment of the present application. As shown in FIG. 3, the bi-directional optical sub-assembly provided in the embodiment may include: a laser chip 11, a Faraday rotator 12, a polarization detection filter 13, a detector chip 14, an optical fiber ferrule 15, a first converging lens 16, a second converging lens 17 and a zero-degree filter 18.

The laser chip 11, the first converging lens 16, the Faraday rotator 12, the polarization detection filter 13 and the optical fiber ferrule 15 are sequentially disposed on the first optical axis, the detector chip 14, the second converging lens 17, and the zero-degree filter 18 are sequentially disposed on the second optical axis, the polarization detection filter 13 is disposed at an intersection point of the first optical axis and the second optical axis that are perpendicular to each other.

Reference may be made to FIG. 4 for the optical path diagram of the bi-directional optical sub-assembly provided in the embodiment. As shown in FIG. 4, polarized light emitted by the laser chip 11 is converged by the first converging lens 16 to the Faraday rotator 12, and after the light is rotated by the Faraday rotator 12, the state of polarization of the light is rotated 45 degrees counterclockwise (from the direction of light emission), polarized light having a state of polarization that is as same as the direction of polarization detection of the polarization detection filter 13 passes through the polarization detection filter 13, and converges at the fiber end face of the optical fiber ferrule 15, so as to be coupled to the fiber in the optical fiber ferrule 15 for transmission. Reflected light reflected from the fiber end face of the optical fiber ferrule 15 and the inside of the fiber has a random state of polarization, in the reflected light, only light having the state of polarization that is as same as the direction of the polarization detection of the polarization detection filter 13 can pass through the polarization detection filter 13, and light having other states of polarization will be reflected, so that the energy of the reflected light passing through the polarization detection filter 13 is greatly reduced. After passing through the Faraday rotator 12, the state of polarization of the reflected light continues to rotate counterclockwise by 45 degrees (from the direction of light emission). The reflected light then passes through the first converging lens 16 to be converged to the laser chip 11. At this time, the state of polarization of the reflected light is rotated by 90 degrees compared to the incident light, the energy of the reflected light is greatly reduced and the state of polarization of the reflected light is perpendicular to the state of polarization of the emitted light and therefore will not affect normal operations of the laser chip 11.

In the embodiment, the state of polarization of the light emitted by the laser chip 11 is 45 degrees from the plane where the bi-directional optical sub-assembly is arranged. After the emitted light is rotated by the Faraday rotator 12, the state of polarization of the emitted light is as same as the direction of polarization detection of the polarization detection filter 13, and thus the emitted light can fully pass through the polarization detection filter 13.

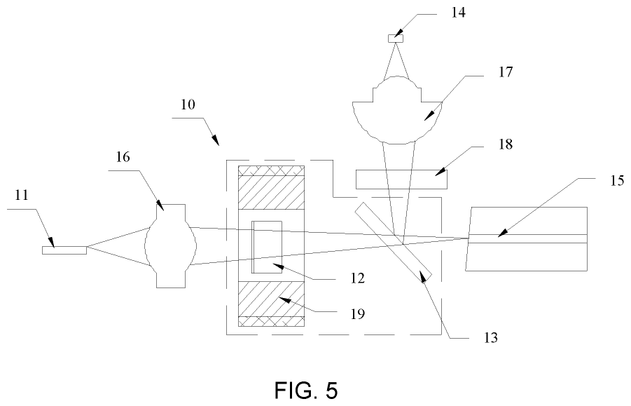

FIG. 5 is a schematic structural diagram of a bi-directional optical sub-assembly according to an embodiment of the present application. As shown in FIG. 5, based on the above embodiments, the Faraday rotator 12 of the bi-directional optical sub-assembly according to the embodiment is further provided with a magnetic ring 19. The positional relationship of the components may refer to the foregoing embodiments, and details are not repeated herein.

The embodiment of the present application further provides an optical module, which includes the bi-directional optical sub-assembly describe in any one of the above embodiments. In some embodiments, the optical module may further include a housing for encapsulating the bi-directional optical sub-assembly.

Those of ordinary skill in the art should understand that all or part of steps to implement the various method embodiments described above may be accomplished by hardware associated with program instructions. The said program can be stored in a computer readable storage medium, where the program, when executed, implements the steps including the foregoing method embodiments. The foregoing storage medium includes various media that can store program codes, such as a ROM, a RAM, a magnetic disk, or an optical disk.

At last, it should be noted that the above embodiments are merely illustrative of the technical solutions of the present application and are not intended to be limiting. Although the present application has been described in detail with reference to the foregoing embodiments, those skilled in the art will understand that the technical solutions described in the foregoing embodiments may be modified, or that some or all of the technical features may be equivalently substituted; these modifications or substitutions do not deviate the nature of the corresponding technical solution from the scope of the technical solutions of various embodiments according to the present application.

What is claimed is:

1. A bi-directional optical sub-assembly, comprising: a laser chip, a Faraday rotator, a polarization detection filter, a detector chip, and an optical fiber ferrule;
the laser chip, the Faraday rotator, the polarization detection filter and the optical fiber ferrule are sequentially disposed on a first optical axis, wherein the detector chip is disposed on a second optical axis, the polarization detection filter is disposed on an intersection point of the first optical axis and the second optical axis in an inclined manner;
the Faraday rotator is configured to rotate polarized light emitted by the laser chip, wherein a direction of state of polarization of the rotated polarized light is as same as a direction of polarization detection of the polarization detection filter; and
the polarization detection filter is configured to inject the rotated polarized light into the optical fiber ferrule and reflect light from the optical fiber ferrule to the detector chip.

2. The optical sub-assembly according to claim 1, wherein the first optical axis is perpendicular to the second optical axis.

3. The optical sub-assembly according to claim 1, wherein a surface of the polarization detection filter is alternately deposited with a film layer having a first refractive index and a film layer having a second refractive index, and wherein the first refractive index is greater than the second refractive index.

4. The optical sub-assembly according to claim 3, wherein the film layer having the first refractive index is a film layer of tantalum pentoxide Ta₂O₅, and the film layer having the second refractive index is a film layer of silicon dioxide SiO₂.

5. The optical sub-assembly according to claim 1, further comprising: a first converging lens, wherein the first converging lens is disposed on the first optical axis and located between the laser chip and the Faraday rotator, and the first converging lens is configured to converge the polarized light emitted by the laser chip to the Faraday rotator.

6. The optical sub-assembly according to claim 1, further comprising: a second converging lens, wherein the second converging lens is disposed on the second optical axis and located between the detector chip and the polarization detection filter, and the second converging lens is configured to converge the light reflected by the polarization detection filter to the detector chip.

7. The optical sub-assembly according to claim 6, further comprising: a zero-degree filter, wherein the zero-degree filter is disposed on the second optical axis and located between the second converging lens and the polarization detection filter, and the zero-degree filter is configured to isolate an interference optical signal.

8. The optical sub-assembly according to claim 1, wherein the light emitted by the laser chip has a wavelength of 1490 nm, and light received by the detector chip has a wavelength of 1310 nm.

9. The optical sub-assembly according to claim 1, wherein an angle between the polarization detection filter and the first optical axis is (45±0.5) degrees.

10. An optical module, comprising: a bi-directional optical sub-assembly; wherein the bi-directional optical sub-assembly comprises a laser chip, a Faraday rotator, a polarization detection filter, a detector chip, and an optical fiber ferrule;
the laser chip, the Faraday rotator, the polarization detection filter and the optical fiber ferrule are sequentially disposed on a first optical axis, wherein the detector chip is disposed on a second optical axis, the polarization detection filter is disposed on an intersection point of the first optical axis and the second optical axis in an inclined manner;
the Faraday rotator is configured to rotate polarized light emitted by the laser chip, wherein a direction of state of polarization of the rotated polarized light is as same as a direction of polarization detection of the polarization detection filter; and
the polarization detection filter is configured to inject the rotated polarized light into the optical fiber ferrule and reflect light from the optical fiber ferrule to the detector chip.

11. The optical module according to claim 10, wherein the first optical axis is perpendicular to the second optical axis.

12. The optical module according to claim 10, wherein a surface of the polarization detection filter is alternately deposited with a film layer having a first refractive index and a film layer having a second refractive index, and wherein the first refractive index is greater than the second refractive index.

13. The optical module according to claim 12, wherein the film layer having the first refractive index is a film layer of tantalum pentoxide Ta₂O₅, and the film layer having the second refractive index is a film layer of silicon dioxide SiO₂.

14. The optical module according to claim 10, wherein the bi-directional optical sub-assembly further comprises a first converging lens, wherein the first converging lens is disposed on the first optical axis and located between the laser chip and the Faraday rotator, and the first converging lens is configured to converge the polarized light emitted by the laser chip to the Faraday rotator.

15. The optical module according to claim 10, wherein the bi-directional optical sub-assembly further comprises a second converging lens, wherein the second converging lens is disposed on the second optical axis and located between the detector chip and the polarization detection filter, and the second converging lens is configured to converge the light reflected by the polarization detection filter to the detector chip.

16. The optical module according to claim 15, wherein the bi-directional optical sub-assembly further comprises a zero-degree filter, wherein the zero-degree filter is disposed on the second optical axis and located between the second converging lens and the polarization detection filter, and the zero-degree filter is configured to isolate an interference optical signal.

17. The optical module according to claim 10, wherein the light emitted by the laser chip has a wavelength of 1490 nm and light received by the detector chip has a wavelength of 1310 nm.

18. The optical module according to claim 10, wherein an angle between the polarization detection filter and the first optical axis is (45±0.5) degrees.
